(19) United States
(12) Patent Application Publication
(10) Pub. No.: US 2018/0150379 A1
(43) Pub. Date: May 31, 2018

(54) METHOD AND SYSTEM OF VERIFYING SOFTWARE

(71) Applicants: Daniel Ratiu, München (DE); Sundaresan Sorakayalpet Arumugam, Chennai (IN)

(72) Inventors: Daniel Ratiu, München (DE); Sundaresan Sorakayalpet Arumugam, Chennai (IN)

(21) Appl. No.: 15/718,241

(22) Filed: Sep. 28, 2017

Related U.S. Application Data
(60) Provisional application No. 62/426,808, filed on Nov. 28, 2016.

(51) Int. Cl. G06F 11/36; G06F 9/44; G06F 9/45; G06F 17/30; G06F 3/0481

(52) U.S. Cl. CPC G06F 11/3608; G06F 8/35; G06F 8/33; G06F 3/0481; G06F 8/20; G06F 17/30731; G06F 8/433

(57) ABSTRACT

A method and system for verifying software in an integrated-development environment is disclosed. In one embodiment, a method of verifying different implementations of a software component in the integrated development environment includes generating a formal similarity specification based on relationships between a set of inputs associated with a first implementation of the software component and a set of inputs associated with a second implementation of the software component, and a set of rules to be satisfied between the outputs of the first implementation and the outputs of the second implementation. The method includes generating programming language statements based on the first implementation of the software component, the second implementation of the software component and the formal similarity specification. Moreover, the method includes verifying similarity of the first implementation of software component and the second implementation using the programming language statements.

This application claims the benefit of U.S. Provisional Application No. 62/426,808 titled ‘METHOD AND SYSTEM OF VERIFYING SOFTWARE,’ filed Nov. 28, 2016, which is herein incorporated by reference in its entirety.

### FIELD OF TECHNOLOGY

The present disclosure generally relates to the field of software development, and more particularly relates to method and system for verifying software.

### BACKGROUND

As development of software progresses from prototype phase to implementation phase, software components evolve from an implementation that is functional to an implementation that satisfies both functional and non-functional requirements. However, the two implementations may not yield same results. For example, during the initial stages of software development, programmers develop the software using floating point signals (data represented as real numbers) and tend to use fixed point implementation (data represented as integers) during deployment stages especially as some devices which would execute the software do not support floating point implementation. For example in fixed point implementation, a real world value such as 15.4 m/s is represented as 154.

Programmers may need to verify that two implementations of software are similar in terms of the outputs generated by the two implementations. In other words, programmers need to verify whether the outputs of the two implementations satisfy rules that define ‘similarity’ of the outputs. Currently, the programmers verify the two implementations by generating and feeding a set of test vectors to the two implementations. The coverage of code by the test vectors is measured. New test vectors are added to the set of test vectors till full coverage of code is measured. The outputs of the two implementations are compared. If the results of the two implementations are similar for all test vectors in the set of test vectors, then the two implementations are declared as similar. However, such kind of verification using test vectors is not accurate as it is difficult to achieve full coverage of code. As a result, the verification of the software may be erroneous. Consequently, the system executing the software may behave in a faulty manner.

### SUMMARY

The scope of the present disclosure is defined solely by the appended claims and is not affected to any degree by the statements within this description. The present embodiments may obviate one or more of the drawbacks or limitations in the related art.

A method and system for verifying software in an integrated development environment is disclosed. In one aspect, a computer-implemented method of verifying different implementation of a software component in an integrated development environment includes generating a formal similarity specification based on relationships between a set of inputs associated with a first implementation of the software component and a set of inputs associated with a second implementation of the software component, and a set of rules to be satisfied between outputs of the first implementation and outputs of the second implementation. The method includes generating programming language statements based on the first implementation of the software component and the second implementation of the software component and the formal similarity specification. Moreover, the method includes verifying similarity of the first implementation of software component and the second implementation using the programming language statements.

The method may include generating a data dictionary specifying range constraints corresponding to the set of inputs of the first implementation and the set of inputs of the second implementation. The method may include generating a control flow graph based on generated programming language statements, and determining whether the first implementation and the second implementation are similar based on the generated control flow graph. In an exemplary implementation, the method may include determining whether the set of inputs to the first implementation and the second implementation satisfy the relationship between the set of inputs. If the set of inputs satisfy the relationship, the method may include determining whether the set of inputs are within the range constraints in the data dictionary. If the set of inputs are within the range constraints, the method may include determining whether the output of the first implementation and output of the second implementation satisfy the set of rules.

If the first implementation and the second implementation are similar, the method may include generating a notification indicating that the first implementation is similar to the second implementation on a graphical user interface. If the first implementation and the second implementation are not similar, the method may include determining at least one rule which is not satisfied by one of the first implementation and the second implementation. Furthermore, the method may include determining the set of inputs corresponding to the first implementation and the second implementation which lead to violation of the at least one rule. Moreover, the method may include outputting the at least one rule which is not satisfied and corresponding set of inputs which lead to the violation of the at least one rule on the graphical user interface.

Also, the method may include modifying at least one of the first implementation and the second implementation if the first implementation and the second implementation are not similar. Additionally, the method may include determining the relationships between the set of inputs corresponding to the first implementation and the set of inputs corresponding to the second implementation. Furthermore, the method may include determining the set of rules to be satisfied between outputs of the first implementation and the second implementation.

In another aspect, a data processing system includes a processing unit, and a memory coupled to the processing unit. The memory includes a software verification module configured to generate a formal similarity specification based on relationships between a set of inputs associated with a first implementation of the software component and a set of inputs associated with a second implementation of the software component, and a set of rules to be satisfied between outputs of the first implementation and outputs of the second implementation. The software verification module is configured to generate programming language statements based on the first implementation of the software component, the second implementation of the software component, and the formal similarity specification. Moreover, the software verification module is configured to verify similarity of the first implementation of software component and the second implementation using the programming language statements.

The software verification module may be configured to generate a data dictionary specifying range constraints corresponding to the set of inputs of the first implementation and the set of inputs of the second implementation. The software verification module may be configured to generate a control flow graph based on generated programming language statements, and determine whether the first implementation and the second implementation are similar based on the generated control flow graph. In one embodiment, the software verification module may be configured to determine whether the set of inputs to the first implementation and the second implementation satisfy the relationship between the set of inputs. The software verification module may be configured to determine whether the set of inputs are within the range constraints in the data dictionary if the set of inputs satisfy the relationship. The software verification module may be configured to determine whether the outputs of the first implementation and the second implementation satisfy the set of rules if the set of inputs are within the range constraints.

The software verification module may be configured to generate a notification indicating that the first implementation is similar to the second implementation on a graphical user interface if the first implementation and the second implementation are similar. The software verification module may be configured to determine at least one rule which is not satisfied by one of the first implementation and the second implementation if the first implementation and the second implementation are not similar. Moreover, the software verification module may be configured to determine the set of inputs corresponding to the first implementation and the second implementation which lead to violation of the at least one rule, and output the at least one rule which is not satisfied and corresponding set of inputs which lead to the violation of the at least one rule on the graphical user interface.

Also, the software verification module may be configured to modify at least one of the first implementation and the second implementation if the first implementation and the second implementation are not similar. Furthermore, the software verification module may be configured to determine the relationships between the set of inputs corresponding to the first implementation and the set of inputs corresponding to the second implementation. Additionally, the software verification module may be configured to determine the set of rules to be satisfied between outputs of the first implementation and the second implementation.

In yet another aspect, a non-transitory computer-readable storage medium, having instructions stored therein, which when executed by a data processing system, cause the data processing system to perform a method of verifying different implementations of a software component. The method includes generating a formal similarity specification based on relationships between a set of inputs associated with a first implementation of a software component and a set of inputs associated with a second implementation of a software component, and a set of rules to be satisfied between outputs of the first implementation and outputs of the second implementation. The method includes generating programming language statements based on the first implementation of software component, the second implementation of software component and the formal similarity specification, and verifying similarity of the first implementation of software component and the second implementation using the programming language statements.

The method may include generating a control flow graph based on generated programming language statements, and determining whether the first implementation and the second implementation are similar based on the generated control flow graph. In an exemplary embodiment, the method may include determining whether the set of inputs to the first implementation and the second implementation satisfy the relationship between the set of inputs. If the set of inputs satisfy the relationship, the method may include determining whether the set of inputs are within range constraints in a data dictionary. If the set of inputs are within the range constraints, the method may include determining whether the outputs of the first implementation and the second implementation satisfy the set of rules.

The method may include generating a notification indicating that the first implementation is similar to the second implementation on a graphical user interface if the first implementation and the second implementation are similar. Also, the method may include determining at least one rule which is not satisfied by one of the first implementation and the second implementation if the first implementation and the second implementation are not similar. Furthermore, the method may include determining the set of inputs corresponding to the first implementation and the second implementation which lead to violation of the at least one rule, and outputting the at least one rule which is not satisfied and corresponding set of inputs which lead to the violation of the at least one rule on the graphical user interface.

Additionally, the method may include modifying at least one of the first implementation and the second implementation if the first implementation and the second implementation are not similar. Also, the method may include determining the relationships between the set of inputs corresponding to the first implementation and the set of inputs corresponding to the second implementation. Moreover, the method may include determining the set of rules to be satisfied between outputs of the first implementation and the second implementation from a plurality of rule sets.

### BRIEF DESCRIPTION OF THE DRAWINGS

A more complete appreciation of the present disclosure and many of the attendant aspects thereof will be readily obtained as the same becomes better understood by reference to the following description when considered in connection with the accompanying drawings:

FIG. 1 illustrates a block diagram of a data processing system in which an embodiment may be implemented;

FIG. 2 illustrates a process flowchart of an exemplary method of verifying different implementations of a software component in an integrated-development environment, according to an embodiment; and

FIG. 3 illustrates a block diagram of another data processing system in which an embodiment may be implemented.

### DETAILED DESCRIPTION

A method and system for verifying software in an integrated-development environment is disclosed. Various embodiments are described with reference to the drawings, wherein like reference numerals are used to refer to like elements throughout. In the following description, numerous specific details are set forth in order to provide thorough understanding of embodiments of the present disclosure. It will be apparent to one skilled in the art, that these specific details need not be employed to practice embodiments of the present disclosure. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure.

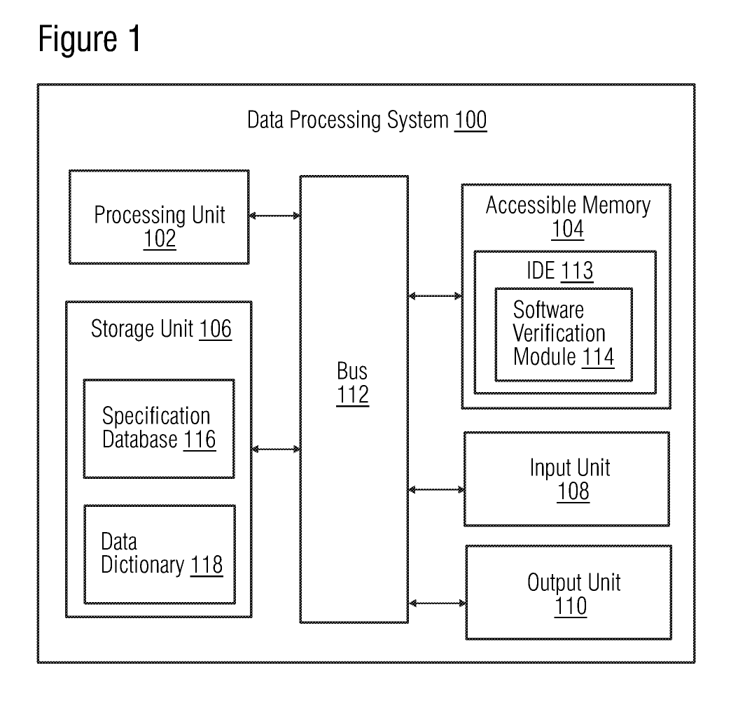

FIG. 1 illustrates a block diagram of a data processing system 100 in which an embodiment may be implemented, for example, as a data processing system particularly configured by software or otherwise to perform the processes as described herein. The data processing system 100 may be a personal computer, a laptop computer, a tablet, smart phone, and the like. In FIG. 1, the data processing system 100 includes a processing unit 102, an accessible memory 104, a storage unit 106, an input unit 108, an output unit 110, and a bus 112.

The processing unit 102, as used herein, refers to any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 102 may also include embedded controllers, such as generic or programmable logic devices or arrays, application specific integrated circuits, single-chip computers, and the like.

The memory 104 may be volatile memory and non-volatile memory. The memory 104 may be coupled for communication with the processing unit 102. The processing unit 102 may execute instructions and/or code stored in the memory 104. A variety of computer-readable storage media may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 104 includes an integrated-development environment (IDE) 113. The IDE 113 includes a software verification module 114 stored in the form of machine-readable instructions on any of the above-mentioned storage media and may be in communication to and executed by processing unit 102.

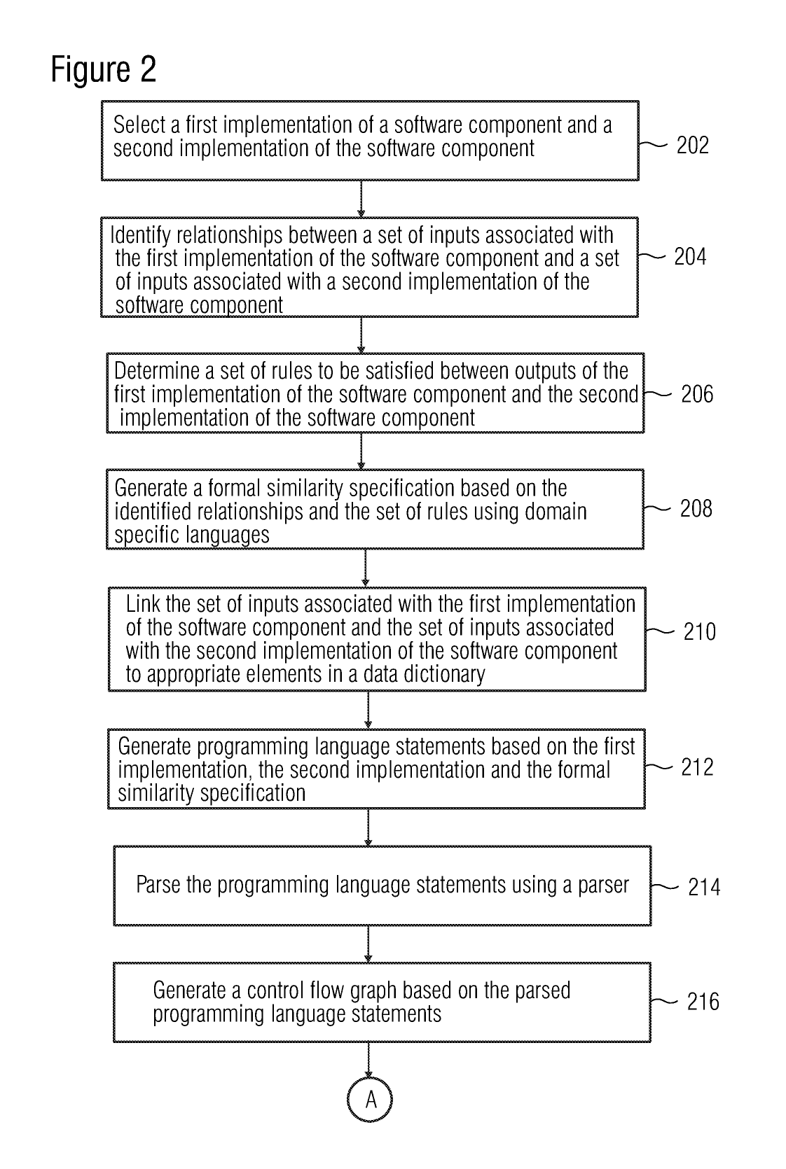

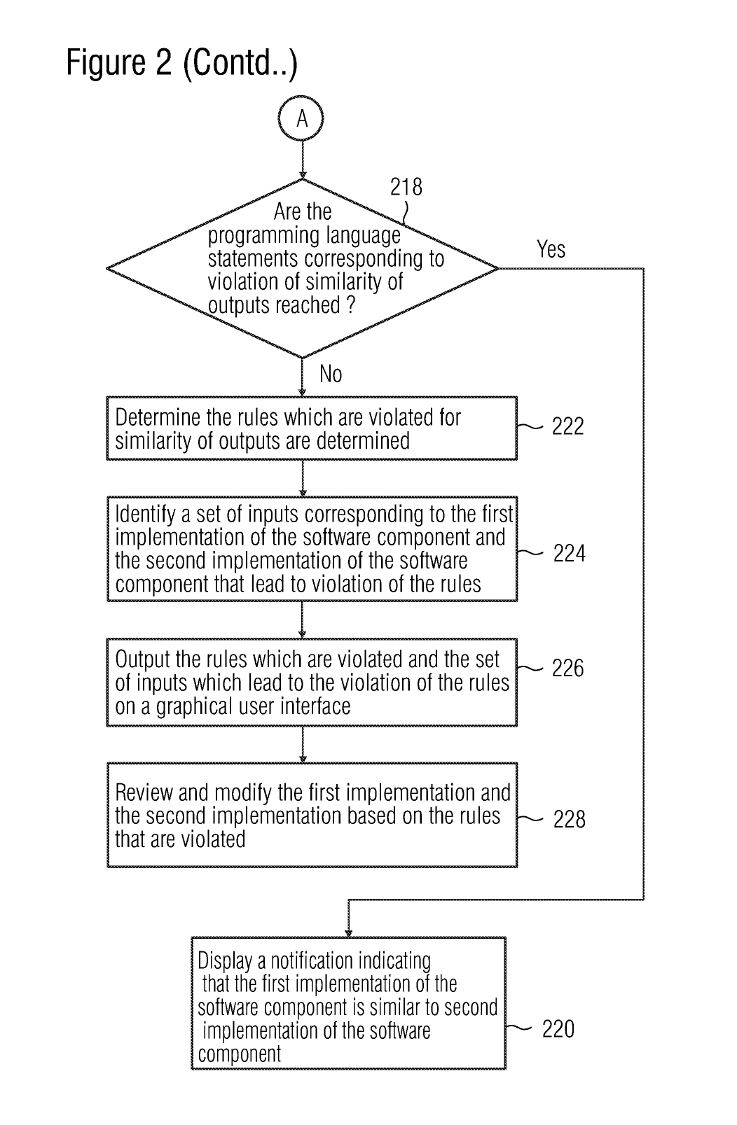

When executed by the processing unit 102, the software verification module 114 causes the processing unit 102 to generate a formal similarity specification based on relationship between the sets of inputs corresponding to the two implementations of software component, and a set of rules to be satisfied between outputs of the two implementations of the software component, generate programming language statements based on the first implementation, the second implementation, and the formal similarity specification, and verify similarity of the two implementations of the software component. Using the programming language statements, the processing unit 102 determines whether input values to the two implementations satisfy the relationship between the set of inputs corresponding to the two implementations, and the input values to the two implementations are within pre-defined range constraints. If these conditions are satisfied, the processing unit 102 determines whether the outputs of the two implementations satisfy the set of rules. The processing unit 102 determines that the two implementations of the software component are similar if the outputs satisfy the set of rules. The processing unit 102 generates a notification if at least one rule is violated. Accordingly, the processing unit 102 enables modifying the implementations to address violation of the at least one rule. Method acts performed by the processing unit 102 to achieve the above functionality are described in greater detail in FIG. 2.

The storage unit 106 may be a non-transitory storage medium which stores a specification database 116 and a data dictionary 118. The specification database 116 stores a formal similarity specification associated with different implementations of software component. The data dictionary 118 stores data type and range properties corresponding to a set of inputs of the different implementation of the software component.

The input unit 108 may include a keypad, touch-sensitive display, camera (such as a camera receiving gesture-based inputs), or any other input device, system, or mechanism capable of receiving an input signal such as user inputs on rules to be satisfied by two implementations, relationship between the inputs of the two implementations, etc., and user commands to verify outputs of the two implementations of the software in the IDE 113 and to modify the implementations if the verification is unsuccessful. The output unit 110 may be configured to display a graphical user interface that visualizes verification errors associated with the verified software. The output unit 110 also provides a graphical user interface which enables to interact with the IDE 113. The bus 112 acts as interconnect between the processing unit 102, the memory 104, the storage unit 106, the input unit 108, and the output unit 110.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

Disclosed embodiments provide systems and methods that verify equivalence of two implementations (or implementations) of software in an integrated-development environment. In particular, disclosed techniques may generate a formal similarity specification based on relationship between the sets of inputs corresponding to two implementations of software component, and a set of rules to be satisfied between outputs of the two implementations of the software component, and verify whether the outputs of the two implementations satisfy the set of rules to determine similarity between the two implementations.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 100 may conform to any of the various current implementation and practices known in the art.

FIG. 2 illustrates a process flowchart 200 of an exemplary method of verifying software in the IDE 113, according to an embodiment. At act 202, a first implementation of a software component and a second implementation of the software component are selected for verification in the IDE 113. For example, the first implementation may be floating point implementation of a function and the second implementation may be fixed point implementation of the function. The floating point implementation for computing sine of half of input angle is shown in APPENDIX ‘A’ in which the angle and its sine value are real numbers. The same function implemented in the fixed point notation is shown in APPENDIX ‘B’, wherein the angle and its sine value are represented as integers. The angle has a scaling of one whereas the sine value has a scaling of 64. Hence, there would be loss of accuracy.

At act 204, relationship between a set of inputs associated with the first implementation of the software component and a set of inputs associated with a second implementation of the software component are identified. In one embodiment, the relationship between the inputs to the implementations is determined based type of implementations. In an exemplary implementation, the relationship between the inputs to the implementations is defined using domain specific language. For example, relationship between inputs may be expressed as: Input to fixed point implementation=input to floating point implementation rounded to a nearest integer. Advantageously, the accuracy due to scaling between the two implementations is not lost by determining relationship between the inputs of the first implementation and the second implementation.

At act 206, a set of rules to be satisfied between outputs of the first implementation of the software component and the second implementation of the software component are determined. The set of rules determine similarity of the outputs of the two implementations. The set of rules may specify acceptable tolerances in cases where identical results cannot be expected. For example, a rule to be satisfied if the outputs of the fixed point implementation divided by 64 needs to be within the resolution of one-bit in the fixed point notation of the output of the floating point implementation (e.g., 1/64). The rule to be satisfied may be expressed as: Output of fixed point implementation=64*output of floating point implementation±1

At act 208, a formal similarity specification is generated based on the identified relationships and the set of rules using domain specific language. An exemplary formal similarity specification to verify similarity between a floating point implementation and a fixed point implementation is given in APPENDIX ‘C’. At act 210, the set of inputs associated with the first implementation of the software component and the set of inputs associated with the second implementation of the software component are linked to appropriate elements in a data dictionary 118. For example, the elements define data type and range properties corresponding to the set of inputs. The range properties may include range constraints and unit associated with each range constraint. The data dictionary 118 allows the programmer to specify the range constraints of each of the inputs. For example, range constraint for angle in floating point may be defined in the data dictionary 118 as ‘−120 to +120’. The data dictionary 118 helps in optimizing time taken for verifying the two implementations because the data dictionary 118 reduces scope of satisfiability problem.

At act 212, programming language statements are generated based on the first implementation, the second implementation, and the formal similarity specification using the data dictionary 118. For example, the programming language statements are generated in C language. The programming language statements corresponding to the determined relationships between the inputs, and the range constraints in the data dictionary 118 are posited as assumptions that are true while the programming language statements corresponding to the set of rules to be satisfied between the outputs of the two implementations are posited as properties that need to be verified. For example, the relationship between the inputs to the first and second implementations may be expressed in C language as:

```
/*
* Relationships between the inputs
*/
{
  _CPROVER_assume( ((int8_t )(_BLOCK_1_theta)) ==
  _BLOCK_2_theta);
}
```

The range constraints corresponding to the inputs may be expressed in C language as:

```
/*
* Data dictionary constraints
*/
{
  _CPROVER_assume( _BLOCK_1_theta >= −120.0 &&
  _BLOCK_1_theta <= 120.0);
  _CPROVER_assume( _BLOCK_2_theta >= −120 &&
  _BLOCK_2_theta <= 120);
}
```

The set of rules to be satisfied between outputs of the first and second implementations are:

```
/*
* Rules that are to be satisfied by the outputs
*/
{
  _COMPARATOR_RES1_ = ((int8_t )((64 * _BLOCK_1_res))) −
  _BLOCK_2_res <= 1;
  _COMPARATOR_RES2_ = _BLOCK_2_res − ((int8_t )((64 *
  _BLOCK_1_res))) <= 1;
}
if ( ! (_COMPARATOR_RES1_ && _COMPARATOR_RES1_ ) )
}
  entrySimFor_FloatFix:
  0;
}
```

In some embodiments, markers indicating a link between the programming language statements and a model are inserted at appropriate location in the programming language statements so that violation of the set of rules corresponding to the set of inputs determined using the programming language statements may be transformed back to the model using the markers in the programming language statements.

At act 214, the programming language statements are parsed using a parser. At act 216, a control flow graph is generated based on the parsed programming language statements. In an exemplary implementation, a first sub-control flow graph for the first implementation is generated based on the corresponding parsed programming language statements. For example, the first sub-control flow graph is generated by adding a branch node if an ‘if’ statement is encountered in the corresponding parsed programming language statements. The ‘if’ path and ‘else’ path in the corresponding parsed programming language statements is branched out of the branch node. Also, a second sub-control flow graph for the second implementation is generated based on the corresponding parsed programming language statements. A control flow graph is generated by combining the first sub-control graph and the second sub-control graph. Thereafter, a plurality of nodes (nodes X) representing the set of rules is added to end of the control flow graph based on the corresponding parsed programming statements. Each node (node X) may represent a rule in the set of rules. The number of nodes may depend on number of valid inputs. Also, a node (node Y) which indicates if all the rules in the set of rules are satisfied is added at the end of the control flow graph. Additionally, a determination node (node Z) which may determine whether one or more rules are satisfied or not is added between the last node of the second implementation and the end nodes (nodes X and node Y).

At act 218, it is determined whether the nodes representing the programming language statements which correspond to the set of rules to be satisfied are reached for a valid set of inputs using the control flow graph. In an exemplary implementation, a C-level model checker determines whether a valid set of inputs lead to violation of the set of rules which define similarity of the outputs. In this implementation, the C-level model checker traverses through a path in the control flow graph which starts from the valid set of inputs and leads to violation of the set of rules to be satisfied (nodes X). For example, the C-level model checker uses a decision procedure to traverse through paths of the control flow graph starting from the set of inputs and leading to nodes corresponding to the set of rules to be satisfied. The decision procedure may be logic such as Bit-vector logic including non-linear arithmetic and arrays to solve reachability of path represented as a Boolean satisfiability problem. In an exemplary implementation, the determination node determines whether the set of rules are satisfied or not. If the set of rules are satisfied, the node (node Y) is reached. If at least one rule is not satisfied, the corresponding node (node X) is reached.

If it is determined that the nodes corresponding to the set of rules are not reached (i.e., the set of rules are satisfied), then at act 220, a notification indicating that the first implementation of the software component is similar to second implementation of the software component is displayed on a graphical user interface. If is it determined that the nodes corresponding to the at least one rule are reached (i.e., the set of rules are not satisfied), then at act 222, the at least one rule which is violated for similarity of outputs are determined. At act 224, a set of inputs corresponding to the first implementation of the software component and the second implementation of the software component that lead to violation of the corresponding rule are identified. At act 226, the rule which is violated and the set of inputs which lead to the violation of the corresponding rule are outputted on a graphical user interface. In an exemplary implementation, the set of inputs and the rule that are violated are transformed back to a model (e.g., formal specification) and are displayed in the IDE 113. For example, the markers inserted in the programming language statements establish a link between the model and the programming language statements. This enables transformation of the violations of the rules by the set of inputs detected in the programming language statements back to the model.

At act 228, the first implementation and the second implementation of the software component are reviewed and modified based on the rule that is violated such that their outputs satisfy the set of rules for the valid range of inputs. The process is routed to act 218 and the acts 218 to 228 are repeated till the outputs satisfy the set of rules.

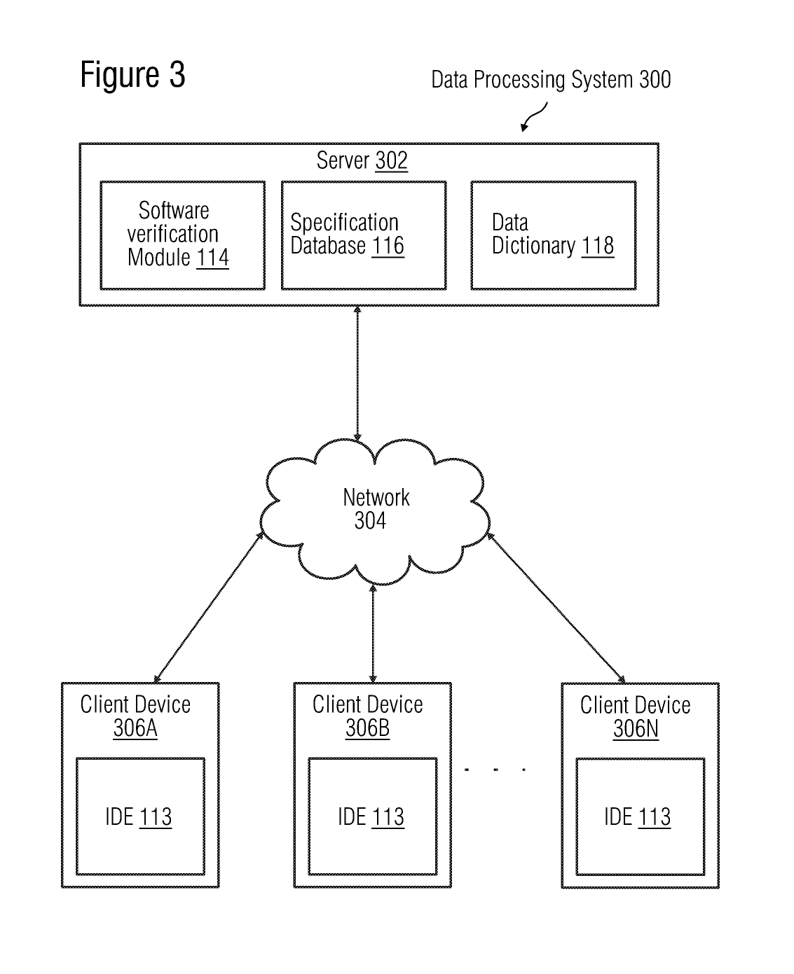

FIG. 3 illustrates a block diagram of another data processing system 300 in which an embodiment may be implemented. Particularly, the data processing system 300 includes a server 302 and a plurality of client devices 306A-N. Each of the client devices 306A-N is connected to the server 302 via a network 304 (e.g., Local Area Network (LAN), Wide Area Network (WAN), Wi-Fi, etc.). The data processing system 300 is another implementation of the data processing system 100 of FIG. 1, wherein the software verification module 114 resides in the server 302 and is accessed by client devices 306A-N via the network 304.

The server 302 includes the software verification module 114, the specifications database 116, and the data dictionary 118. The server 302 may also include a processing unit, a memory, and a storage unit. The software verification module 114 may be stored on the memory in the form of machine-readable instructions and executable by the processing unit. The specifications database 116 and the data dictionary 118 may be stored in the storage unit. The server 302 may also include a communication interface for enabling communication with client devices 306A-N via the network 304.

When the machine-readable instructions are executed, the software verification module 114 causes the server 302 to generate a formal similarity specification based on relationship between a set of inputs corresponding to two implementations of the software component, and a set of rules to be satisfied between outputs of the two implementations of the software component, generate programming language statements based on the first implementation, the second implementation and the formal similarity specification, and verify similarity of the two implementations of the software component. Method acts performed by the server 302 to achieve the above-mentioned functionality are described in greater detail in FIG. 2. The client devices 306A-N include the integrated-development environment (IDE) 113 which enable software engineers to access the software verification module 114 in the server 302 to verify the software in the manner described above.

One may envision that, the software verification module 114 may reside in a cloud server in a cloud computing environment, wherein the client devices 306A-N connected via a cloud network may access the software verification module 114 to automatically verify the software.

In various embodiments, the methods and systems illustrated in FIGS. 1 to 3 automatically verifies equivalence of different implementations of a software component based on domain specific language. The systems and methods consider entire space of inputs for verifying the two implementations. The systems and methods translates a formal specification into programming language statements which are analyzed by a model checker to determine compliance to a set of rules that in turn demonstrate equivalence of the two implementations and translates output of the model checker to the formal specification in the form of set of inputs which lead to violation of rules. The systems and methods provide formal way of verifying the two implementations in accurate and efficient manner without any false positives or false negatives.

It is to be understood that the system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that contains, stores, communicates, propagates, or transports the program for use by or in connection with the instruction execution system, apparatus, or device. The medium may be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and digital versatile disc (DVD). Both processors and program code for implementing each aspect of the technology may be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

What is claimed is:

1. A computer-implemented method of verifying different implementations of a software component in an integrated development environment, the method comprising:
generating, by a data processing system, a formal similarity specification based on relationships between a set of inputs associated with a first implementation of a software component and a set of inputs associated with a second implementation of a software component, and a set of rules to be satisfied between outputs of the first implementation and outputs of the second implementation;
generating programming language statements based on the first implementation of software component, the second implementation of software component, and the formal similarity specification; and
verifying a similarity of the first implementation of software component and the second implementation using the programming language statements.

2. The method of claim 1, further comprising:
generating a data dictionary specifying range constraints corresponding to the set of inputs of the first implementation and the set of inputs of the second implementation.

3. The method of claim 2, wherein the verifying of the similarity comprises:
generating a control flow graph based on generated programming language statements;
determining whether the first implementation and the second implementation are similar based on the generated control flow graph;
when the first implementation and the second implementation are similar, generating a notification indicating that the first implementation is similar to the second implementation on a graphical user interface;
when the first implementation and the second implementation are not similar, determining at least one rule which is not satisfied by one of the first implementation and the second implementation;
determining the set of inputs corresponding to the first implementation and the second implementation which lead to violation of the at least one rule; and
outputting the at least one rule which is not satisfied and corresponding set of inputs which lead to the violation of the at least one rule on the graphical user interface.

4. The method of claim 1, further comprising:
modifying at least one of the first implementation and the second implementation when the first implementation and the second implementation are not similar.

5. The method of claim 1, further comprising:
determining the relationships between the set of inputs corresponding to the first implementation and the set of inputs corresponding to the second implementation.

6. The method of claim 1, further comprising:
determining the set of rules to be satisfied between outputs of the first implementation and the second implementation.

7. The method of claim 3, wherein the determining of whether the first implementation and the second implementation are similar comprises:
determining whether the set of inputs to the first implementation and the second implementation satisfy the relationship between the set of inputs;
when the set of inputs satisfy the relationship, determining whether the set of inputs are within the range constraints in the data dictionary; and
when the set of inputs are within the range constraints, determining whether the outputs of the first implementation and the second implementation satisfy the set of rules.

8. A data processing system comprising:
a processing unit; and
a memory coupled to the processing unit, wherein the memory comprises a software verification module configured to:
generate a formal similarity specification based on relationships between a set of inputs associated with a first implementation of a software component and a set of inputs associated with a second implementation of a software component, and a set of rules to be satisfied between outputs of the first implementation and outputs of the second implementation;
generate programming language statements based on the first implementation of software component, the second implementation of software component, and the formal similarity specification; and
verify a similarity of the first implementation of software component and the second implementation using the programming language statements.

9. The data processing system of claim 8, wherein the software verification module is configured to generate a data dictionary specifying range constraints corresponding to the set of inputs of the first implementation and the set of inputs of the second implementation.

10. The data processing system of claim 9, wherein, in verifying the similarity of the first implementation of software component and the second implementation using the programming language statements, the software verification module is configured to:
generate a control flow graph based on generated programming language statements;
determine whether the first implementation and the second implementation are similar based on the generated control flow graph;
generate a notification indicating that the first implementation is similar to the second implementation on a graphical user interface when the first implementation and the second implementation are similar;
determine at least one rule which is not satisfied by one of the first implementation and the second implementation when the first implementation and the second implementation are not similar;
determine the set of inputs corresponding to the first implementation and the second implementation which lead to violation of the at least one rule; and
output the at least one rule which is not satisfied and corresponding set of inputs which lead to the violation of the at least one rule on the graphical user interface.

11. The data processing system of claim 8, wherein the software verification module is configured to modify at least one of the first implementation and the second implementation when the first implementation and the second implementation are not similar.

12. The data processing system of claim 8, wherein the software verification module is configured to determine the relationships between the set of inputs corresponding to the first implementation and the set of inputs corresponding to the second implementation.

13. The data processing system of claim 8, wherein the software verification module is configured to:
determine the set of rules to be satisfied between outputs of the first implementation and the outputs of the second implementation.

14. The data processing system of claim 10, wherein in determining whether the first implementation and the second implementation are similar, wherein the software verification module is configured to:
determine whether the set of inputs to the first implementation and the second implementation satisfy the relationship between the set of inputs;
determine whether the set of inputs are within the range constraints in the data dictionary when the set of inputs satisfy the relationship; and
determine whether the outputs of the first implementation and outputs of the second implementation satisfy the set of rules when the set of inputs are within the range constraints.

15. A non-transitory computer-readable storage medium having instructions stored therein, which when executed by a data processing system, cause the data processing system to:
generate a formal similarity specification based on relationships between a set of inputs associated with a first implementation of a software component and a set of inputs associated with a second implementation of a software component, and a set of rules to be satisfied between outputs of the first implementation and outputs of the second implementation;
generate programming language statements based on the first implementation of software component, the second implementation of software component and the formal similarity specification; and
verify similarity of the first implementation of software component and the second implementation using the programming language statements.

16. The computer-readable storage medium of claim 15, wherein, in verifying the similarity of the first implementation of software component and the second implementation using the programming language statements, the instructions cause the data processing system to:
generate a control flow graph based on generated programming language statements;
determine whether the first implementation and the second implementation are similar based on the generated control flow graph;
generate a notification indicating that the first implementation is similar to the second implementation on a graphical user interface when the first implementation and the second implementation are similar;
determine at least one rule which is not satisfied by one of the first implementation and the second implementation when the first implementation and the second implementation are not similar;
determine the set of inputs corresponding to the first implementation and the second implementation which lead to violation of the at least one rule; and
output the at least one rule which is not satisfied and corresponding set of inputs which lead to the violation of the at least one rule on the graphical user interface.

17. The computer-readable storage medium of claim 15, wherein the instructions cause the data processing system to:
modify at least one of the first implementation and the second implementation when the first implementation and the second implementation are not similar.

18. The computer-readable storage medium of claim 15, wherein the instructions cause the data processing system to:
determine the relationships between the set of inputs corresponding to the first implementation and the set of inputs corresponding to the second implementation.

19. The computer-readable storage medium of claim 15, wherein the instructions cause the data processing system to:
determine the set of rules to be satisfied between outputs of the first implementation and the second implementation from a plurality of rule sets.

20. The computer-readable storage medium of claim 16, wherein in determining whether the first implementation and the second implementation are similar, the instructions cause the data processing system to:
determine whether the set of inputs to the first implementation and the second implementation satisfy the relationship between the set of inputs;
determine whether the set of inputs are within range constraints in a data dictionary when the set of inputs satisfy the relationship; and
determine whether the outputs of the first implementation and the second implementation satisfy the set of rules when the set of inputs are within the range constraints.
